(19) United States
(12) Patent Application Publication
(10) Pub. No.: US 2011/0231900 A1
(43) Pub. Date: Sep. 22, 2011

(54) APPARATUS, METHOD, AND COMPUTER-READABLE MEDIUM FOR DISTRIBUTING ACCESS CONTROL INFORMATION

(75) Inventor: Tatsuji SHIMOE, Kawasaki (JP)

(73) Assignee: FUJITSU LIMITED, Kawasaki-shi (JP)

(21) Appl. No.: 13/045,653

(22) Filed: Mar. 11, 2011

(30) Foreign Application Priority Data
Mar. 18, 2010 (JP) 2010-62697

(51) Int. Cl. G06F 21/00

(52) U.S. Cl. 726/1

(57) ABSTRACT

An access-control-information distributing apparatus includes: a processor configured to determine a destination device to which access control information is to be distributed, the access control information describing an object on an information processing device and a condition which permits access to the object, on the basis of at least the condition or an attribute of the object.

### CROSS-REFERENCE TO RELATED APPLICATIONS

This application is based upon and claims the benefit of priority of the prior Japanese Patent Application No. 2010-062697, filed on Mar. 18, 2010, the entire contents of which are incorporated herein by reference.

### FIELD

The embodiment(s) discussed herein relate(s) to access-control-information distributing apparatuses, methods, and computer-readable mediums.

### BACKGROUND

Various access control methods have been proposed in which, when a user logs into a server, operations the user can perform on objects (e.g., resources including files, programs, software, and systems and Web services) on the server are controlled. Examples of such access control methods include role-based access control (RBAC) and an access control list (ACL). In RBAC, roles corresponding to job titles, qualifications, or organizations are associated with accessible objects. In ACLS, each user or group is associated with accessible objects. RBAC is used in high-level middleware, such as Web single sign-on (SSO) systems, while ACLS are used in operating systems (OS) etc.

For example, in RBAC, users assigned role X can perform all operations (e.g., adding, deleting, and viewing) on system X, while users assigned role Y are permitted only to perform viewing on system X. In this manner, RBAC allows access control in which roles are associated with operations that can be performed on an object. On the other hand, an ACL specifies operations permitted on system X for each user.

However, with the access control methods described above, it is difficult to make a complex determination of whether access is permitted on the basis of a plurality of conditions, such as a data (object) attribute, information about a specified authentication method, and an operational rule. A data attribute is information related to data, such as whether the data is confidential information, information for internal use, or information available to the outside. Information about a specified authentication method refers to information about an authentication method used in determining whether access is permitted, such as information as to whether access to an object requires only entry of a user ID and a password, or requires biometrics. An operational rule refers to a condition related to operations, such as time during which an object is accessible.

Accordingly, access control methods using access control policies have been proposed in recent years. With abstract description in eXtensible Application Markup Language (XAML) etc., an access control policy can define conditions for access to an object. For example, an access control policy can define conditions “Internal-use-only information is accessible to users authenticated with biometrics and smart card, weekdays from 9:00 to 17:00”, including a data attribute, information about a specified authentication method, and an operational rule.

As for access control policies, a method has been proposed in which a set of access control policies suitable for a given access control apparatus is automatically converted to a set of access control policies suitable for another access control apparatus (see, e.g., Japanese Unexamined Patent Application Publication No. 2005-332049).

However, this technique may not take into account the speed of access control using access control policies and the load imposed during such access control.

### SUMMARY

According to an aspect of the embodiment, an access-control-information distributing apparatus includes: a processor configured to determine a destination device to which access control information is to be distributed, the access control information describing an object on an information processing device and a condition which permits access to the object, on the basis of at least the condition or an attribute of the object.

The object and advantages of the embodiment will be realized and attained at least by the elements, features, and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 illustrates an access control system including a policy distributing apparatus of the present invention.

FIG. 2 illustrates a hardware configuration of the policy distributing apparatus.

FIG. 3 is a functional block diagram illustrating a mechanism for realizing functions of the policy distributing apparatus.

FIG. 4 is a flowchart illustrating a process executed by the policy distributing apparatus.

FIG. 5 is a conceptual diagram illustrating a relationship between security policies and an access control policy.

FIG. 6A to FIG. 6C illustrate security policies.

FIG. 7 illustrates an access-control-policy management table.

FIG. 8A illustrates a destination-information management table.

FIG. 8B illustrates a distribution-policy management table.

FIG. 9A illustrates a structure of a distribution-destination management table.

FIG. 9B illustrates a distribution-destination management table that stores destination information for each access control policy.

FIG. 10 illustrates a configuration of an access control system in which whether access is permitted is determined centrally by an authorization server.

FIG. 11 is a flowchart illustrating a process of determining the types of devices to which an access control policy is to be distributed.

FIG. 12 is a flowchart illustrating another process of determining the types of devices to which an access control policy is to be distributed.

FIG. 13 is a flowchart illustrating another process of determining the types of devices to which an access control policy is to be distributed.

### DESCRIPTION OF EMBODIMENTS

Embodiments of the present invention will now be described with reference to the drawings.

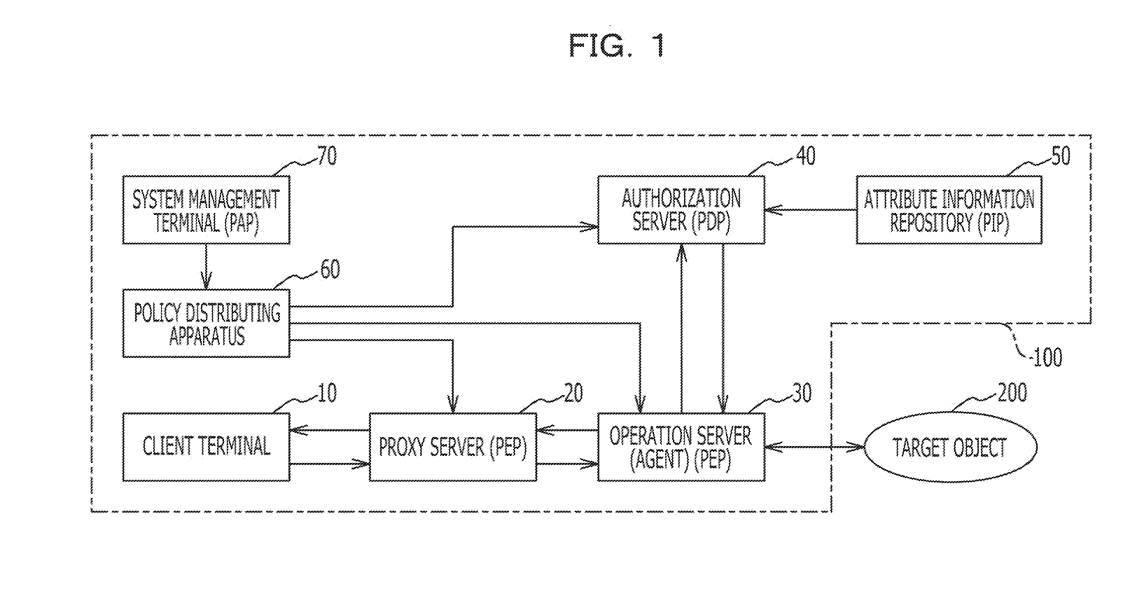

FIG. 1 illustrates a configuration of an access control system including a policy distributing apparatus of the present invention. In FIG. 1, a device that manages (generates, verifies, distributes, etc.) security policies (access control principles) is indicated as a policy administration point (PAP), a device that makes a determination of whether access is permitted on the basis of an access control policy (access control information) is indicated as a policy decision point (PDP), and a device that actually controls whether to allow access is indicated as a policy enforcement point (PEP). A device that provides user IDs, object IDs, and attribute information for the PDP to determine whether access is permitted is indicated as a policy information point (PIP).

An access control system 100 includes a client terminal 10, a proxy server 20, an operation server 30, an authorization server 40, an attribute information repository 50, a policy distributing apparatus 60, and a system management terminal 70.

The client terminal 10 is, for example, a personal computer. A user accesses an object on the operation server 30 from the client terminal 10. The concept of “access” includes not only the ability to simply connect to an object, but also the ability to perform specific operations (viewing, writing, reading, deleting, etc.) on the object. However, for simplicity of explanation in the present embodiment, the term “access” refers to using an object. When the user requests access to an object on the operation server 30, the client terminal 10 requests issue of credit information called credentials from a credit-information issuing device (e.g., single sign-on management system) and obtains the credentials. The client terminal 10 transmits an access request for access to the operation server 30 and the obtained credentials to the proxy server 20. In FIG. 1, the object that the user has requested to access, the object being present on the operation server 30, is indicated as a target object 200.

The proxy server 20 receives the access request and the credentials transmitted from the client terminal 10. Upon receipt of the access request, the proxy server 20 determines whether there is an access control policy for the target object 200. Access control policies are stored, for example, in a memory of the proxy server 20. If there is the access control policy, the proxy server 20 determines, on the basis of the access control policy, whether the user of the client terminal 10 is permitted to access the target object 200.

If the user of the client terminal 10 does not meet conditions defined by the access control policy, the proxy server 20 denies the user access to the target object 200. If the user meets conditions defined by the access control policy, the proxy server 20 transmits the access request and the credentials to the operation server 30. Even when there is no access control policy for the target object 200, the proxy server 20 transmits the access request and the credentials to the operation server 30.

The operation server 30 is, for example, a server computer. The operation server 30 includes an agent module (indicated as “agent” in the drawing) that determines, on the basis of an access control policy, whether the user is permitted to access the target object 200.

The operation server 30 receives the access request and the credentials from the proxy server 20. The operation server 30 determines whether there is an access control policy for the target object 200. If there is the access control policy, the agent module in the operation server 30 determines, on the basis of the access control policy, whether the user is permitted to access the target object 200. If the user does not meet conditions defined by the access control policy, the operation server 30 denies the user access to the target object 200.

On the other hand, if the user meets conditions defined by the access control policy, the operation server 30 transmits the access request and the credentials to the authorization server 40. Even when there is no access control policy for the target object 200, the operation server 30 transmits the access request and the credentials to the authorization server 40. The operation server 30 obtains a result of determination made by the authorization server 40 as to whether the user is permitted to access the target object 200. On the basis of the result of this determination obtained from the authorization server 40, the operation server 30 controls the access from the client terminal 10 to the target object 200.

The authorization server 40 receives the access request and the credentials from the operation server 30. The authorization server 40 determines whether there is an access control policy for the target object 200. If there is an access control policy, the authorization server 40 determines, on the basis of the access control policy, whether the user is permitted to access the target object 200. The authorization server 40 uses information contained in the credentials to obtain user attribute information (e.g., an age, and a department to which the user belongs) from the attribute information repository 50, and uses it to determine whether access is permitted. The authorization server 40 transmits the result of the determination to the operation server 30. If there is no access control policy for the target object 200, the authorization server 40 transmits an access permission signal to the operation server 30.

As described above, in the access control system 100 illustrated in FIG. 1, the proxy server 20, the operation server 30, and the authorization server 40 sequentially make determinations as to whether access is permitted.

The attribute information repository 50 stores IDs of users and objects on the operation server 30, attribute information about the users and the objects, etc.

The policy distributing apparatus 60 receives, from the system management terminal 70, security policies (described in detail below) from which access control policies are generated. The policy distributing apparatus 60 generates an access control policy from security policies. The policy distributing apparatus 60 distributes an appropriate access control policy to the proxy server 20, the operation server 30, and the authorization server 40.

The system management terminal 70 receives security policies input by security administrators (e.g., chief security officers (CSOs), department heads, and data owners). The system management terminal 70 outputs the received security policies to the policy distributing apparatus 60.

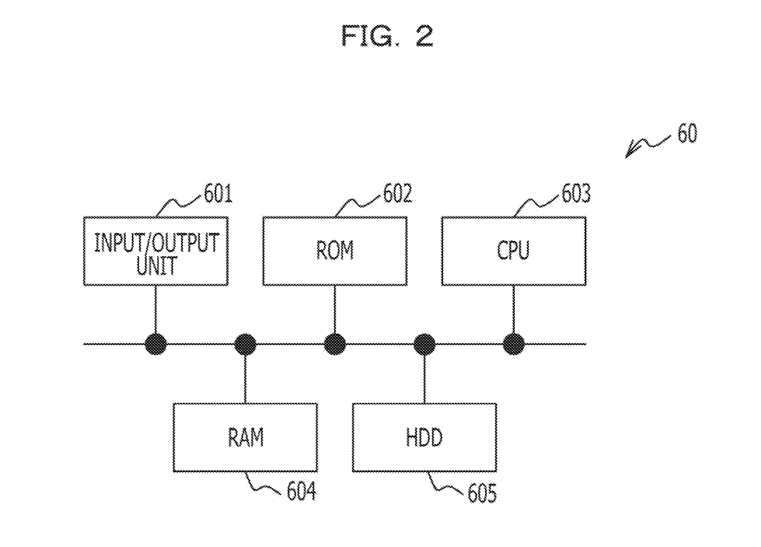

Next, a hardware configuration of the policy distributing apparatus 60 will be described. FIG. 2 illustrates a hardware configuration of the policy distributing apparatus 60.

The policy distributing apparatus 60 includes an input/output unit 601, a read only memory (ROM) 602, a central processing unit (CPU) 603 which is an example of a processor, a random access memory (RAM) 604, and a hard disk drive (HDD) 605.

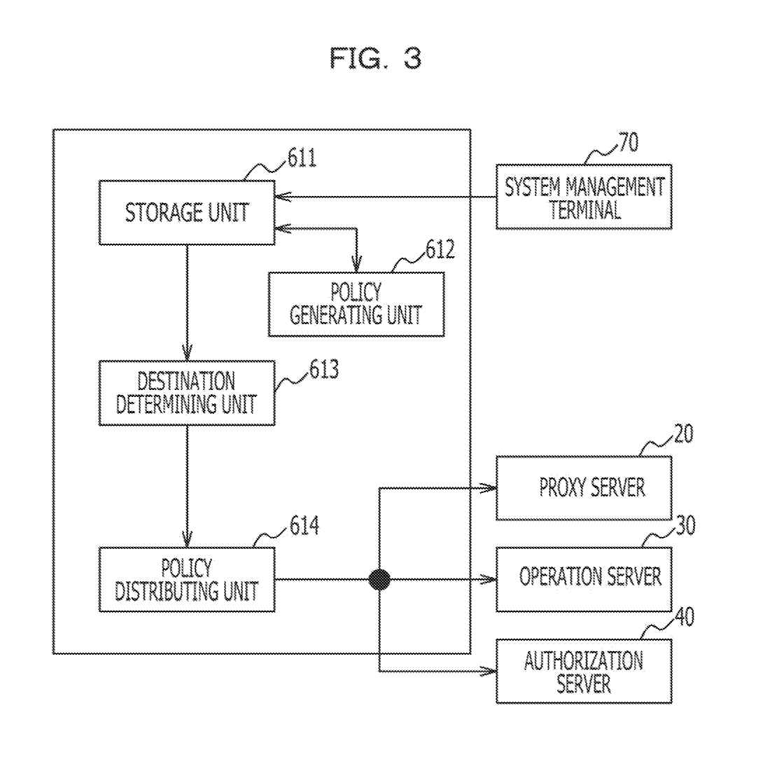

The input/output unit 601 outputs access control policies to the proxy server 20, the operation server 30, and the authorization server 40. Also, the input/output unit 601 receives security policies from the system management terminal 70. The ROM 602 stores, for example, a program for determining where to distribute access control policies (described below). The CPU 603 reads and executes a program stored in the ROM 602. The RAM 604 stores temporary data used in executing a program. The functions of the policy generating unit 612, the destination determining unit 613, and the policy distributing unit 614 illustrated in FIG. 3 are executed though operations performed by the CPU 603 in accordance with a program stored in the ROM 602.

The HDD 605 stores an access-control-policy management table, a destination-information management table, a distribution-policy management table, and a distribution-destination management table (described below).

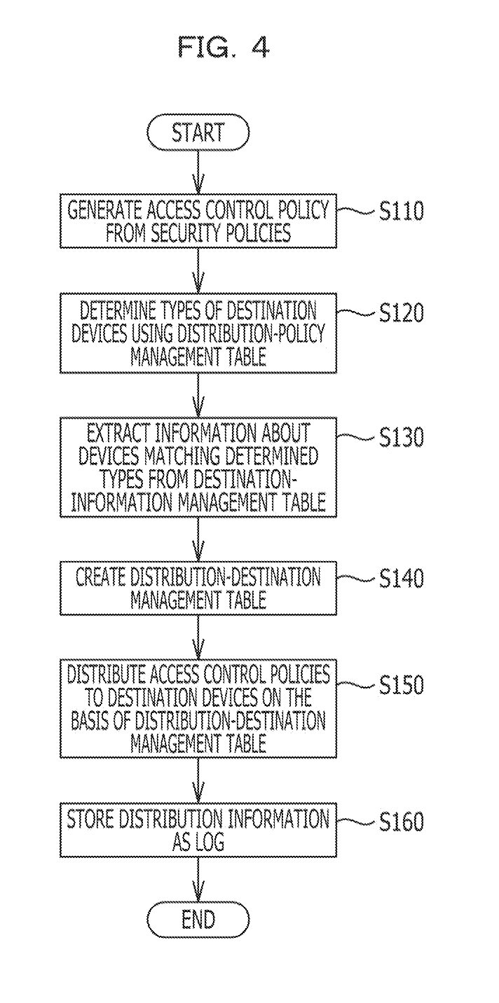

Next, a mechanism for realizing functions of the policy distributing apparatus 60 will be described with reference to a functional block diagram of FIG. 3 and a flowchart of FIG. 4. FIG. 3 is a functional block diagram illustrating a mechanism for realizing functions of the policy distributing apparatus 60. FIG. 4 is a flowchart illustrating a process executed by the policy distributing apparatus 60. The following outlines an operation performed by each block in the functional block diagram of FIG. 3 with reference to the process illustrated in the flowchart of FIG. 4.

As illustrated in FIG. 3, the policy distributing apparatus 60 includes a storage unit 611, a policy generating unit (generating unit) 612, a destination determining unit 613, and a policy distributing unit (distributing unit) 614.

The storage unit 611 stores security policies input from the system management terminal 70, a distribution-policy management table, a destination-information management table, and an access-control-policy management table.

The policy generating unit 612 obtains security policies from the storage unit 611 to generate an access control policy (operation S110 in FIG. 4). The policy generating unit 612 stores the generated access control policy in the access-control-policy management table stored in the storage unit 611.

The security policies, the access-control-policy management table, the destination-information management table, and the distribution-policy management table will now be described.

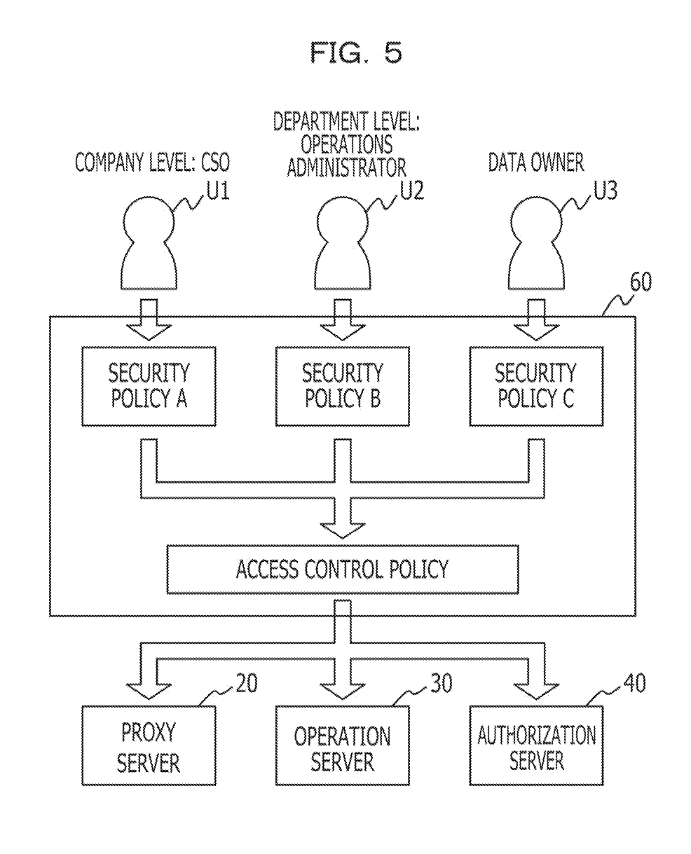

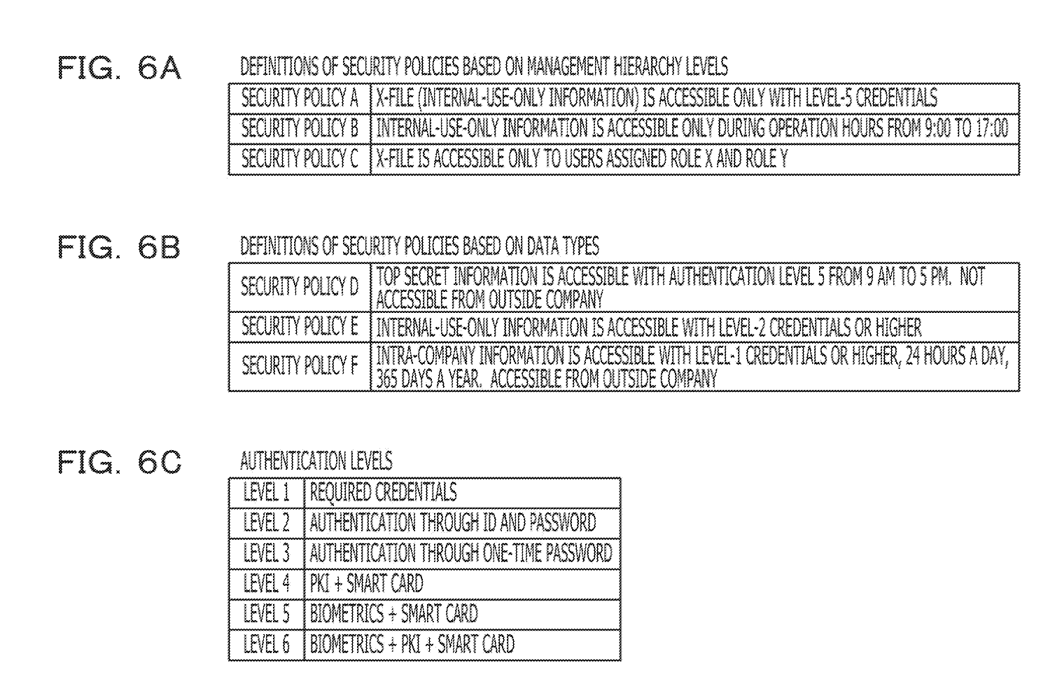

First, with reference to FIG. 5 and FIGS. 6A to 6C, the security policies and the access-control-policy management table will be described. FIG. 5 is a conceptual diagram illustrating a relationship between security policies and an access control policy. FIG. 6A to FIG. 6C illustrate security policies.

Referring to FIG. 5, a user U1 (CSO) inputs, from the system management terminal 70 to the policy distributing apparatus 60, a security policy A to be applied company-wide. For example, as illustrated in FIG. 6A, the user U1 sets the security policy A stating “X-file (internal-use-only information) is accessible with level-5 credentials”.

Authentication levels can be defined as illustrated in FIG. 6C. FIG. 6C illustrates authentication levels and their required credentials. In FIG. 6C, where authentication levels 1 to 5 are defined, level 5 requires three types of authentication: biometrics, public key infrastructure (pki), and smart card.

Referring to FIG. 5, a user U2 (departmental operations administrator) inputs, from the system management terminal 70 to the policy distributing apparatus 60, a security policy B to be applied at a department level. For example, as illustrated in FIG. 6A, the user U2 sets the security policy B stating “Internal-use-only information is accessible only during operation hours from 9:00 to 17:00”.

Referring also to FIG. 5, a user U3 (data owner) inputs a security policy C from the system management terminal 70 to the policy distributing apparatus 60. For example, when the user U3 is a data owner who owns the X-file, the user U3 inputs the security policy C stating “X-file is accessible only to users assigned role X and role Y”, as illustrated in FIG. 6A.

The policy generating unit 612 combines security policies for a common object to generate an access control policy. For example, the security policies A to C described above are for a common object (X-file). Although the security policy B is for internal-use-only information, the X-file is internal-use-only information, as stated in the security policy A. Therefore, the internal-use-only information and the X-file can be regarded as substantially the same object.

On the basis of the security policies A to C, the policy generating unit 612 generates an access control policy stating “X-file is accessible to users assigned role X and role Y, from 9:00 to 17:00, only when using level-5 credentials”. The policy generating unit 612 stores the generated access control policy in the access-control-policy management table.

In the description above, security policies are defined for respective management hierarchy levels, which are the CSO, the departmental operations administrator, and the data owner. Alternatively, as illustrated in FIG. 6B, security policies may be defined for respective data types. If there are three data types, such as top secret information, internal-use-only information, and intra-company information, security policies D to F illustrated in FIG. 6B can be defined for the respective data types.

A process will be described in which the policy generating unit 612 generates an access control policy on the basis of the security policies A to F illustrated in FIG. 6A and FIG. 6B. Here, the X-file is an object common to the security policies A, B, C, and E. However, whereas the security policy A requires level-5 credentials for access to the X-file (internal-use-only information), the security policy E is defined as “Internal-use-only information is accessible with level-2 credentials or higher”. If there is such a contradiction between security policies, the policy generating unit 612 generates an access control policy in accordance with a rule specified by a system administrator. For example, if a rule is defined as “If there is a contradiction in authentication level, a higher authentication level is adopted into the access control policy”, the policy generating unit 612 generates an access control policy in accordance with this rule. Thus, an access control policy generated for the X-file on the basis of the security policies A to F is as follows: “X-file is accessible to users assigned role X and role Y, from 9:00 to 17:00, only when using level-5 credentials”.

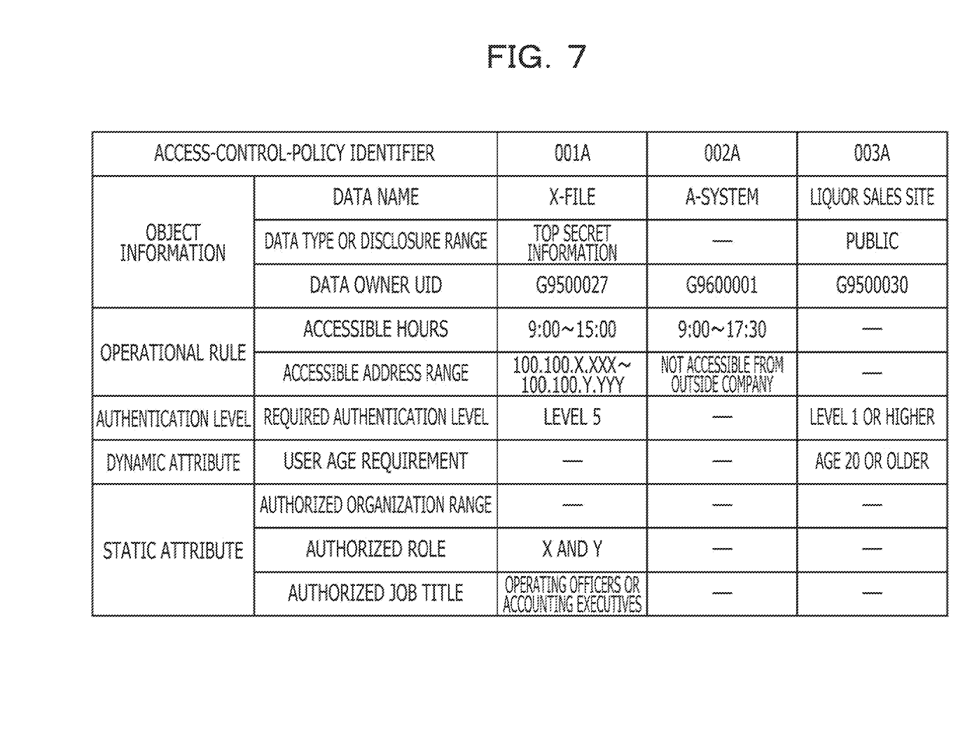

Next, an access-control-policy management table will be described. FIG. 7 illustrates an access-control-policy management table. As illustrated, the access-control-policy management table includes the following items: access-control-policy identifier, data name, data type or disclosure range, user ID of data owner (data owner UID), accessible hours, accessible address range, required authentication level, user age requirement, authorized organization range, authorized role, and authorized job title.

“Access-control-policy identifier” is an identifier for identifying one of a plurality of access control policies and can be, for example, a four-byte alphanumeric string. In the example of FIG. 7, “001A” to “003A” are input as identifiers.

“Data name”, “data type or disclosure range”, and “data owner UID” are categorized as object information. “Data name” is a name of an object to be accessed. For example, a system name, a file name, or a URL/URI is set as a data name. In the example of FIG. 7, “X-file”, “A-system”, and “liquor sales site” are defined as data names. “Data type or disclosure range” defines the type of each object having the above-described data name, such as whether the object is top secret information or public information open to the public. In the example of FIG. 7, the X-file is defined as top secret information, the liquor sales site is defined as public information, and no disclosure range is defined for the A-system. “Data owner UID” indicates an ID of each user who manages the object.

“Accessible hours” and “accessible address range” relate to operational rules which are conditions to be used in determining whether access is permitted. “Accessible hours” define periods of time during which each object having the above-described data name is accessible. In the example of FIG. 7, the X-file is accessible from 9:00 to 15:00, the A-system is accessible from 9:00 to 17:30, and no time restrictions are placed on access to the liquor sales site. “Accessible address range” defines an IP address range which allows access to each object having the above-described data name, or defines whether to permit access to the object from outside the company.

“Required authentication level” relates to authentication levels which are also conditions to be used in determining whether access is permitted. “Required authentication level” defines a credential level necessary to access each object having the above-described data name. In the example of FIG. 7, access to the X-file requires level-5 credentials, while the liquor sales site can be accessed with level-1 credentials (e.g., entry of a user ID and a password) or higher.

“User age requirement” relates to dynamic attributes which are also conditions to be used in determining whether access is permitted. Dynamic attribute conditions relate to user attribute information and object attribute information that change with time. In the example of FIG. 7, a user age, which is user attribute information that changes with time, is categorized as a dynamic attribute. As illustrated, the user age requirement for access to the liquor sales site is age 20 or older.

“Authorized organization range”, “authorized role”, and “authorized job title” relate to static attributes which are also conditions to be used in determining whether access is permitted. Static attribute conditions relate to information that changes less frequently. For example, organizations to which users belong, roles assigned to users, and user job titles, which change less frequently, are categorized as static attributes. In the example of FIG. 7, users authorized to access the X-file are those assigned roles X and Y and, at the same time, are either operating officers or accounting executives.

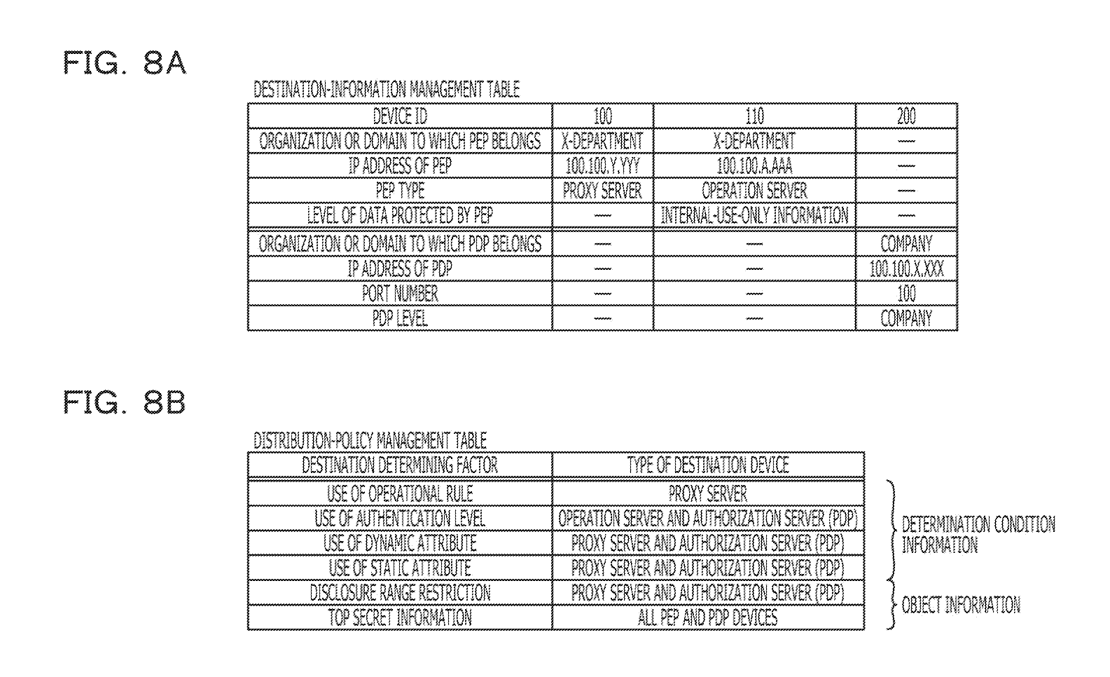

Next, a destination-information management table and a distribution-policy management table will be described with reference to FIG. 8A and FIG. 8B.

FIG. 8A illustrates a destination-information management table. As illustrated, the destination-information management table includes the following items: device ID, organization or domain to which pep belongs, IP address of pep, pep type, level of data protected by pep, organization or domain to which pDp belongs, ip address of pDp, port number, and PDP level.

“Device ID” is an identifier for identifying one of a plurality of devices to which access control policies are to be distributed. In the example of FIG. 8A, devices with device IDs “100,” “110”, and “200” are registered.

The other items following “device ID” include information about devices. If a device is PEP, values for this device are defined for the items from “organization or domain to which pep belongs” to “level of data protected by pep”. If a device is PDP, values for this device are defined for the items from “organization or domain to which pDp belongs” to “pDp level”.

If a device represented by a device ID is PEP, a value representing an organization or a domain to which the device belongs is set for “organization or domain to which pep belongs”. “IP address of pep” indicates an IP address of the device. “PEP type” indicates the type of the device, that is, whether the device is an operation server including an agent module, a proxy server, or the like. “Level of data protected by pep” indicates the level of importance of data protected by the device. The level of data can be defined, for example, as top secret information, internal-use-only information, or public information, as described above.

In the example of FIG. 8A, the devices with device IDs “100” and “110” are registered as PEPs. The device with device ID “100” is a proxy server that belongs to an X-department and has an IP address of “100.100.Y.YYY”. The device with device ID “110” is an operation server that belongs to the X-department, has an IP address of “100.100.A.AAA”, and protects internal-use-only information.

If a device represented by a device ID is PDP, a value representing an organization or a domain to which the device belongs is set for “organization or domain to which pDp belongs”. “ip address of pDp” indicates an IP address of the device. “Port number” indicates a port number of the device. “PDP level” indicates the level of availability of the device, such as whether the device is available at a company level or a department level.

In the example of FIG. 8A, the device with device ID “200” is registered as PDP. The device with device ID “200” is PDP belonging to the company, available at a company level, and having an IP address of “100.100.X.XXX” and a port number of “100”.

FIG. 8B illustrates a distribution-policy management table. A distribution-policy management table is a table that defines the types of destination devices to which access control policies are to be distributed. The distribution-policy management table defines the types of destination devices using determination condition information and object information. Determination condition information is information about conditions used to determine whether access is permitted, and object information is information about a target object. As for determination condition information, one or more destinations to which an access control policy is to be distributed are defined for each of the following types of conditions used to determine whether access is permitted: operational rule, authentication level, dynamic attribute, and static attribute.

In the example of FIG. 8B, when an operational rule is used to determine whether access is permitted, the access control policy is distributed to devices of device type “proxy server”; when an authentication level is used to determine whether access is permitted, the access control policy is distributed to devices of device types “operation server” and “authorization server”; when a dynamic attribute is used to determine whether access is permitted, the access control policy is distributed to devices of device types “proxy server” and “authorization server”; and when a static attribute is used to determine whether access is permitted, the access control policy is distributed to devices of device types “proxy server” and “authorization server”. When multiple types of conditions are used to determine whether access is permitted, destinations of access control policy distribution can be determined such that all destinations defined for the multiple types of conditions are included. For example, when an operational rule and an authentication level are used to determine whether access is permitted, the access control policy is distributed to devices of device types “proxy server”, “operation server”, and “authorization server”.

As for object information, destinations to which an access control policy is to be distributed are defined for each of the following cases: when there is a restriction on the disclosure range of an object, and when an object is top secret information.

In the example of FIG. 8B, when there is a restriction on the disclosure range of an object, the access control policy is distributed to devices of device types “proxy server” and “authorization server”; and when an object is top secret information, the access control policy is distributed to all devices of device types “proxy server”, “operation server”, and “authorization server”.

Referring back to FIG. 3, the functions of the policy distributing apparatus 60 will be described.

The destination determining unit 613 obtains an access-control-policy management table, a distribution-policy management table, and a destination-information management table from the storage unit 611. The destination determining unit 613 uses the access-control-policy management table and the distribution-policy management table to determine one or more types of destination devices for each access control policy (operation S120 in FIG. 4). The destination determining unit 613 extracts information about devices that match the determined types of destination devices from the destination-information management table (operation S130 in FIG. 4) and creates a distribution-destination management table that associates each access control policy with one or more destination devices to which the access control policy is to be distributed (operation S140 in FIG. 4). The destination determining unit 613 outputs the created distribution-destination management table to the policy distributing unit 614.

A process of creating a distribution-destination management table from an access-control-policy management table, a distribution-policy management table, and a destination-information management table will now be described. The destination determining unit 613 obtains an access-control-policy management table, a distribution-policy management table, and a destination-information management table from the storage unit 611.

For each access control policy stored in the access-control-policy management table, the destination determining unit 613 checks one or more conditions to be used in determining whether access is permitted. At substantially the same time, the destination determining unit 613 checks the disclosure range of an object. Next, the destination determining unit 613 obtains, from the distribution-policy management table, a distribution policy that matches the one or more checked conditions and the checked disclosure range.

For example, in the access-control-policy management table illustrated in FIG. 7, the destination determining unit 613 checks the conditions and the disclosure range used to determine whether access to the object “X-file” with access-control-policy identifier “001A” is permitted. The conditions used to determine whether access to the object “X-file” with access-control-policy identifier “001A” is permitted include information about operational rules, an authentication level, and static attributes. Also, as indicated, the X-file is top secret information. Then, from the distribution-policy management table illustrated in FIG. 8B, the destination determining unit 613 obtains the types of destination devices defined for these conditions and for the disclosure range. The destination determining unit 613 determines distribution destinations such that all the obtained types of destination devices are included. Specifically, the destination determining unit 613 determines devices of device types “proxy server”, “operation server”, and “authorization server” as distribution destinations.

The access control policy with identifier “002A” in FIG. 7 uses operational rules to determine whether access is permitted, and places no restrictions on the disclosure range. Therefore, on the basis of the distribution-policy management table illustrated in FIG. 8B, the destination determining unit 613 determines devices of device type “proxy server” as destinations to which the access control policy with identifier “002A” is to be distributed. The access control policy with identifier “003A” in FIG. 7 uses an authentication level and a dynamic attribute to determine whether access is permitted, and defines the disclosure range as “public”. Therefore, the destination determining unit 613 determines devices of device types “proxy server”, “operation server”, and “authorization server” as destinations to which the access control policy with identifier “003A” is to be distributed.

Next, from a destination-information management table, the destination determining unit 613 extracts information about devices that match the determined destination conditions. Specifically, when destinations are proxy servers and operation servers, the destination determining unit 613 extracts, from a destination-information management table such as that illustrated in FIG. 8A, information about devices for which either “proxy server” or “operation server” is set in the item “PEP type”. When destinations are authorization servers, the destination determining unit 613 extracts information about devices for which information about PDP is input.

In the example described above, destinations to which the access control policy for the X-file is to be distributed are devices of device types “proxy server”, “operation server”, and “authorization server”. Therefore, from the destination-information management table illustrated in FIG. 8A, the destination determining unit 613 extracts information about devices of device types “proxy server”, “operation server”, and “authorization server”. That is, the destination determining unit 613 extracts information about the devices with device IDs 100, 110, and 200. Also, destinations to which the access control policy for the A-system is to be distributed are devices of device type “proxy server”. Therefore, from the destination-information management table illustrated in FIG. 8A, the destination determining unit 613 extracts information about the device with device ID 100 for which “proxy server” is set as “PEP type”. Also, destinations to which the access control policy for the liquor sales site is to be distributed are devices of device types “proxy server”, “operation server”, and “authorization server”. Therefore, from the destination-information management table illustrated in FIG. 8A, the destination determining unit 613 extracts information about devices of device types “proxy server”, “operation server”, and “authorization server”. That is, the destination determining unit 613 extracts information about the devices with device IDs 100, 110, and 200.

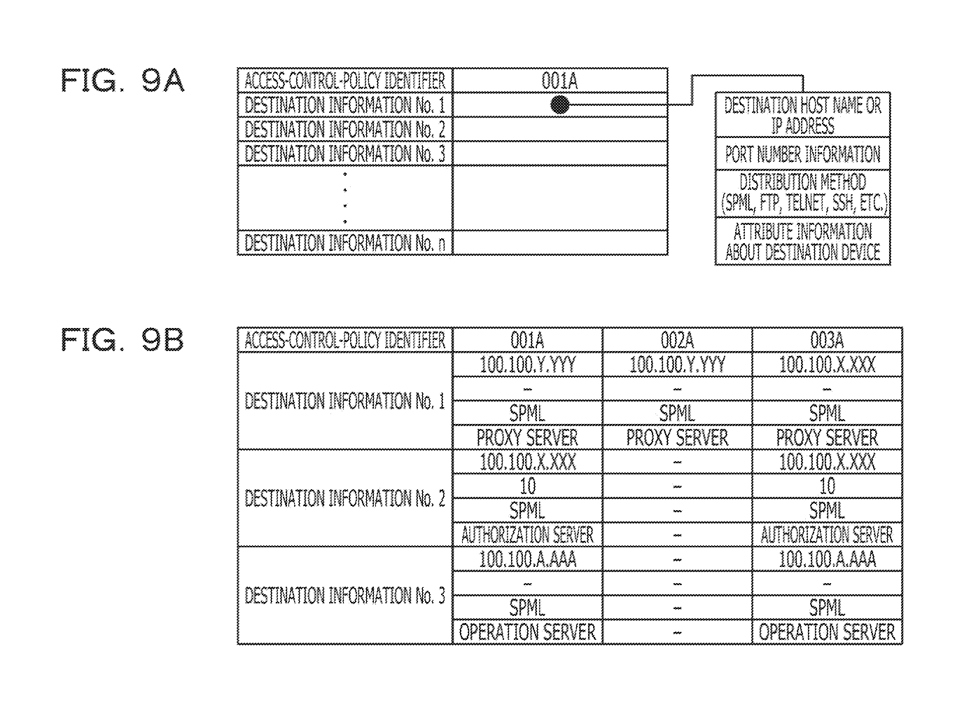

The destination determining unit 613 registers the determined distribution destinations in a distribution-destination management table. FIG. 9A illustrates a structure of a distribution-destination management table. The distribution-destination management table includes the following items: access-control-policy identifier, and destination information.

The item “access-control-policy identifier” includes any of the access-control-policy identifiers registered in the access-control-policy management table illustrated in FIG. 7.

“Destination information No. 1 to No. n” includes information about destinations to which an access control policy identified by an access-control-policy identifier is to be distributed. Destination information includes information for identifying each destination (e.g., a destination host name or IP address, and a port number) and information about how to distribute the access control policy (e.g., Spml, ftp, telnet, or ssh). The destination information may further include attribute information about the destination device.

FIG. 9B illustrates a distribution-destination management table that stores destination information for each access control policy defined in FIG. 7. As described above, the access control policies identified by access-control-policy identifiers “001A” and “003A” are to be distributed to the devices with device IDs 100, 110, and 200. Therefore, the destination information No. 1 to No. 3 is registered for access-control-policy identifiers “001A” and “003A”. Specifically, the destination information for each of access-control-policy identifiers “001A” and “003A” includes information about the proxy server, the authorization server, and the operation server which are distribution destinations. Also, the access control policy identified by access-control-policy identifier “002A” is to be distributed to the device with device ID 100, which is a proxy server. Therefore, in FIG. 9B, for access-control-policy identifier “002A”, only the destination information No. 1 is registered and information about the proxy server is stored. The distribution-destination management table created in this manner is output from the destination determining unit 613 to the policy distributing unit 614.

Referring back to FIG. 3, the policy distributing unit 614 receives the distribution-destination management table from the destination determining unit 613. In accordance with the distribution-destination management table, the policy distributing unit 614 distributes the access control policies to the appropriate devices (operation S150 in FIG. 4). Upon distributing the access control policies, the policy distributing unit 614 stores distribution information as a log (operation S160 in FIG. 4). The distribution information stored as a log includes information about which access control policy has been distributed to which device, and whether the distribution has been completed without error.

On the basis of each access control policy received, the proxy server 20, the operation server 30, and the authorization server 40 each make a determination of whether access is permitted. User access to an object can thus be controlled.

As is apparent from the above description, in the present embodiment, each access control policy can be distributed to different destinations depending on the conditions to be used in determining whether access is permitted. Additionally, the proxy server 20, the operation server 30, and the authorization server 40 can make determinations, in a decentralized manner, as to whether access is permitted. This can reduce load on the authorization server 40 associated with access control, and increase the speed of access control.

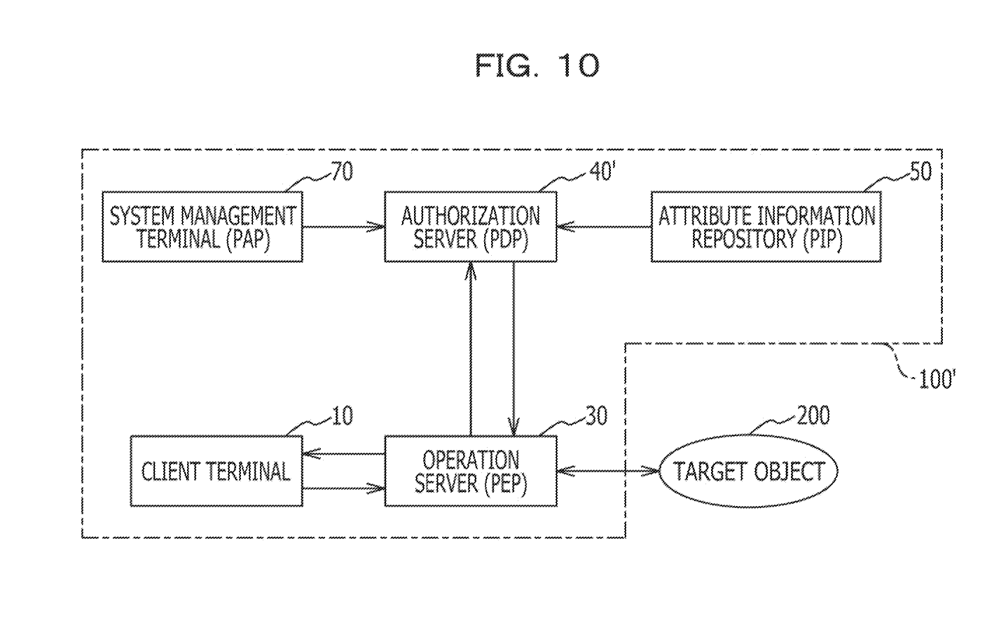

For example, assume that a condition used to determine whether access to a target object is permitted is an operational rule only. As illustrated in FIG. 10, in an access control system 100′ where a determination of whether access is permitted is made centrally by an authorization server 40′, even a determination using a simple condition, such as an operational rule, needs to be made by the authorization server 40′. This results in increased load on the authorization server 40′ and lowers the speed of access control.

In contrast, in the access control system 100 illustrated in FIG. 1, when a condition used to determine whether access is permitted is an operational rule, the access control policy is distributed to the proxy server 20. In this case, since whether access is permitted can be determined by the proxy server 20 alone, it is not necessary for the operation server 30 and the authorization server 40 to make such a determination. This can reduce load on the operation server 30 and the authorization server 40, and increase the speed of access control.

In the present embodiment, access control can be performed at multiple hierarchical levels (multiple layers). Specifically, execution of access control in the proxy server 20 is followed by execution of access control in the operation server 30, and then the authorization server 40 makes a determination of whether access is permitted. Therefore, if a user is denied access to an object at a lower hierarchical level, it is not necessary to execute access control at higher hierarchical levels. It is thus possible to save CPU resources for higher-level devices.

For example, in the access control system illustrated in FIG. 10, where the authorization server 40′ centrally executes access control, if many access requests are received at substantially the same time, the load on the authorization server 40′ is increased and the speed of access control is reduced. On the other hand, in the access control system 100 illustrated in FIG. 1, even when many access requests are received at substantially the same time, if a user is denied access at the proxy server 20, it is not necessary for the operation server 30 and the authorization server 40 at higher hierarchical levels to execute access control. It is thus possible to save CPU resources for the operation server 30 and the authorization server 40.

Also, in the present embodiment, the policy generating unit 612 generates an access control policy by combining security policies which define access determination conditions for the same object. Thus, security policies defined for different management hierarchy levels and data types can be combined into a consistent access control policy and distributed to appropriate devices. Additionally, an access control policy which covers all conditions for the same object is automatically generated from security policies defined for different management hierarchy levels and data types. Therefore, it is less likely to omit description of conditions, as compared to the case where an access control policy is manually generated.

A system administrator manages each security policy, not an access control policy. If a plurality of system administrators perform maintenance on the same access control policy without using security policies, it may be unclear as to who is responsible for the result of access control executed on the basis of the access control policy. However, in the present embodiment, where security policies are managed in accordance with management hierarchy levels or data types, users or organizations to which each security policy belongs are clear. Thus, where responsibility for security lies can be clarified.

In the present embodiment, the policy distributing unit 614 stores distribution information as a log. Thus, the distribution information can be kept as an audit trail log which is information useful in audits.

Although the embodiments of the present invention have been described in detail, the present invention is not limited to specific embodiments and can be variously modified or changed within the scope of the present invention described in the claims.

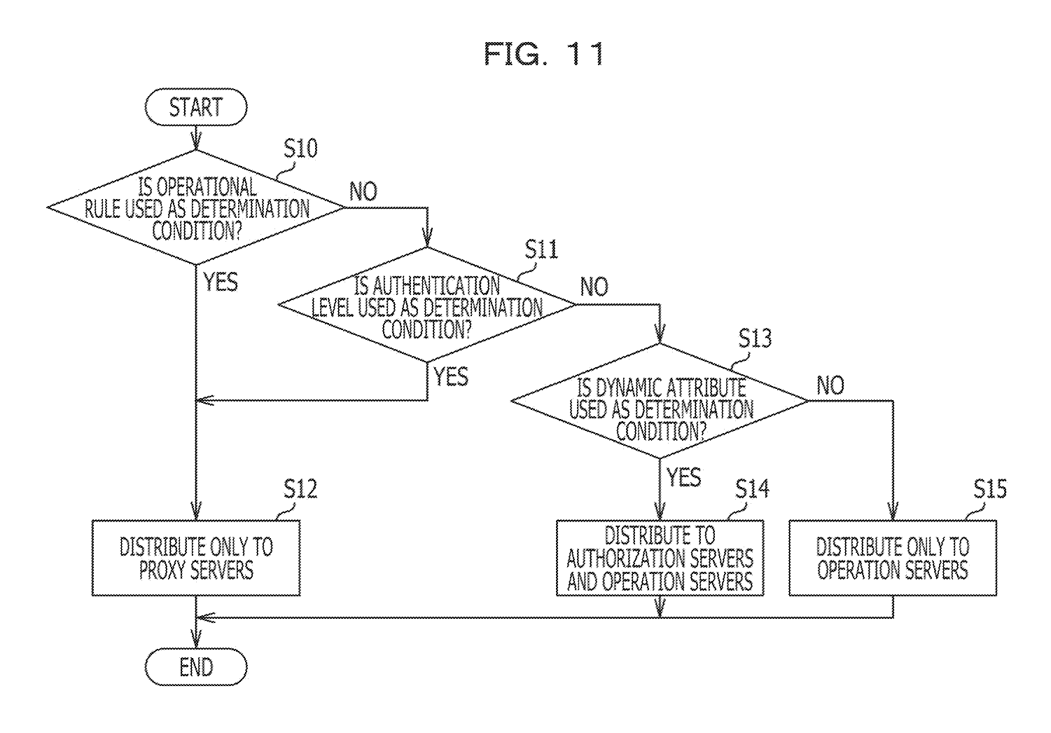

For example, in the embodiments described above, the destination determining unit 613 uses a distribution-policy management table to determine the types of devices to which an access control policy is to be distributed. Alternatively, any of the processes illustrated in the flowcharts of FIG. 11 to FIG. 13 may be used in such a determination.

FIG. 11 is a flowchart illustrating a process of determining the types of devices to which an access control policy is to be distributed. The destination determining unit 613 determines whether, in an access control policy, an operational rule is used as a determination condition for determining whether access is permitted (operation S10). If an operational rule is not used as a determination condition (NO in FIG. 10), the destination determining unit 613 determines whether an authentication level is used as a determination condition (operation S11).

If an operational rule is used as a determination condition (YES in FIG. 10) or if an authentication level is used as a determination condition (YES in FIG. 11), the destination determining unit 613 determines proxy servers as devices to which the access control policy is to be distributed (operation S12).

If an authentication level is not used as a determination condition (NO in FIG. 11), the destination determining unit 613 determines whether a dynamic attribute is used as a determination condition (operation S13). If a dynamic attribute is used as a determination condition (YES in operation S13), the destination determining unit 613 determines authorization servers and operation servers as devices to which the access control policy is to be distributed (operation S14). If a dynamic attribute is not used as a determination condition (NO in operation S13), the destination determining unit 613 determines operation servers as devices to which the access control policy is to be distributed (operation S15).

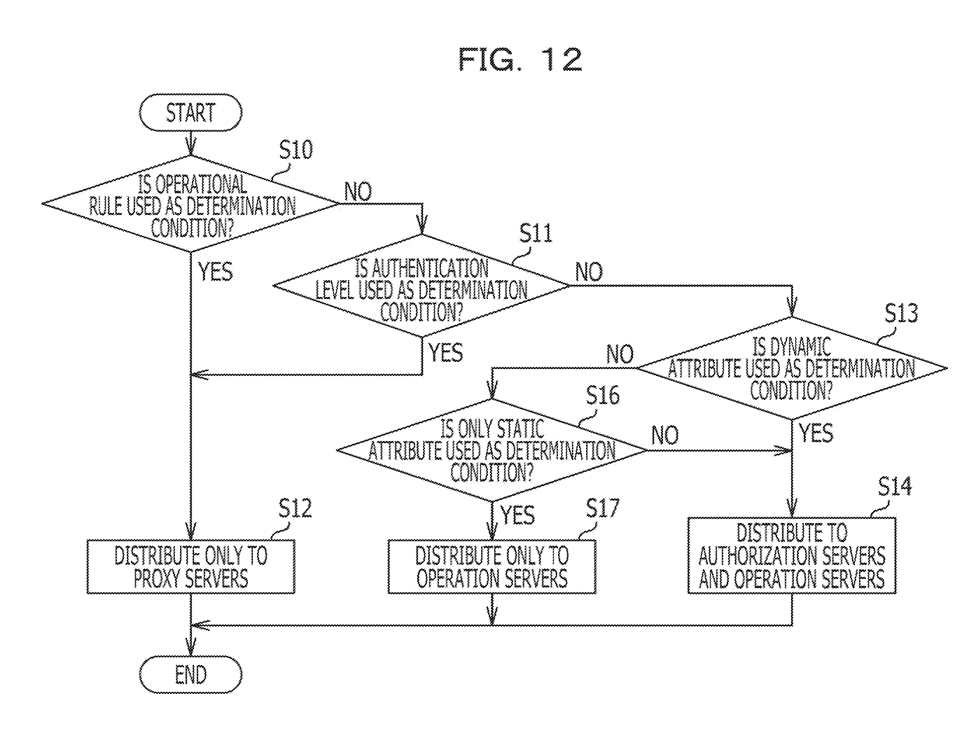

Alternatively, the destination determining unit 613 may determine the types of distribution destination devices as illustrated in the flowchart of FIG. 12. Note that in FIG. 12, the substantially same operations as those in FIG. 11 are given the same operation numbers and their description will be omitted. Only operations different from those in FIG. 11 will now be described.

If a dynamic attribute is not used as a determination condition (NO in operation S13), the destination determining unit 613 determines whether only a static attribute is used as a determination condition (operation S16). If only a static attribute is used as a determination condition (YES in operation S16), the destination determining unit 613 determines only operation servers as devices to which the access control policy is to be distributed (operation S17).

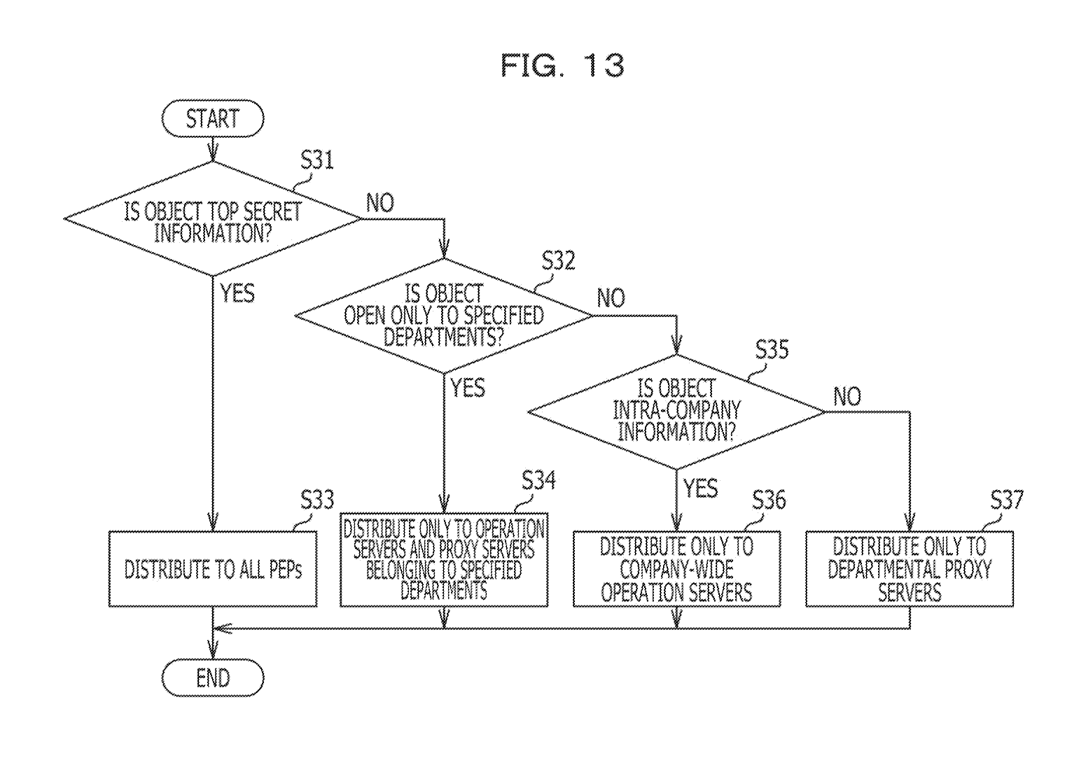

In the processes illustrated in FIG. 11 and FIG. 12, the destination determining unit 613 determines the types of distribution destination devices on the basis of conditions used to determine whether access is permitted. Alternatively, as illustrated in FIG. 13, the destination determining unit 613 may determine the types of distribution destination devices on the basis of an attribute of an object.

In the flowchart of FIG. 13, the destination determining unit 613 first determines, on the basis of an access-control-policy management table, whether an object is top secret information (operation S31). If the object is top secret information (YES in operation S31), the destination determining unit 613 determines all PEPS (proxy servers and operation servers in the present embodiment) as distribution destination devices (operation S33).

If the object is not top secret information (NO in operation S31), the destination determining unit 613 determines whether the object is open only to specified departments (operation S32). If the object is open only to specified departments (YES in operation S32), the destination determining unit 613 determines only operation servers and proxy servers belonging to the specified departments as distribution destination devices (operation S34). Thus, during creation of a distribution-destination management table, the destination determining unit 613 can extract information about distribution destination devices by specifying organizations to which the devices belong, as well as by specifying the types of devices.

If access to the object is not restricted to specified departments (NO in operation S32), the destination determining unit 613 determines whether the object is intra-company information (operation S35). If the object is intra-company information (YES in operation S35), the destination determining unit 613 determines only company-wide operation servers as distribution destination devices (operation S36).

If the object is not intra-company information (NO in operation S35), the destination determining unit 613 determines only departmental proxy servers as distribution destination devices (operation S37). As will be apparent from the above description, the determination of the types of distribution destination devices does not need to be based on a distribution-policy management table. The types of devices may be specified by specifying organizations to which the devices belong, domains of the devices, IP addresses of the devices, etc.

In the embodiments described above, access control policies are distributed to proxy servers, operation servers, and authorization servers. However, the distribution destinations are not limited to them. For example, access control policies may be distributed to network devices, such as hubs, routers, and gateway devices. Also, there may be more than one each of the proxy server 20, the operation server 30, and the authorization server 40 within a system.

Although the policy distributing apparatus 60 includes the storage unit 611 in the embodiments described above, the storage unit 611 may be provided outside the policy distributing apparatus 60. In this case, the policy distributing apparatus 60 can obtain an access-control-policy management table etc. from the storage unit 611, for example, via a network.

The functions of the policy distributing apparatus 60 can be realized by a computer. In this case, a program that describes processing for the functions of the policy distributing apparatus 60 is provided. The functions are realized on the computer when the computer executes the program. The program that describes the processing can be recorded on a computer-readable recording medium.

For circulation, portable recording media, such as digital versatile discs (DVDs) or compact-disc read-only memories (CD-ROMs), on which the program is recorded are sold. Alternatively, the program may be stored in a storage device of a server computer and transferred from the server computer to other computers via a network.

For example, a computer which executes the program may store, in its own storage device, the program recorded on a portable recording medium or the program transferred from the server computer. Then, the computer reads the program from its own storage device and executes processing in accordance with the program. The computer may read the program directly from the portable recording medium to execute processing in accordance with the program. Alternatively, each time the program is transferred from the server computer, the computer may execute processing in accordance with the received program.

For example, an application service provider (ASP) may use a server computer connected to a communication network, such as the Internet, as the policy distributing apparatus of the present invention. In this case, the ASP provides a service that executes processing for determination of distribution destinations etc. from the server computer to information processing apparatuses, such as personal computers, connected to the server computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has (have) been described in detail, it should be understood that the various changes, substitutions, and alterations could be made hereto without departing from the spirit and scope of the invention.

What is claimed is:

1. An apparatus to distribute access control information, the apparatus comprising:
a processor configured to determine a destination device to which access control information is to be distributed, the access control information describing an object on an information processing device and a condition which permits access to the object, on the basis of at least the condition or an attribute of the object.

2. The apparatus according to claim 1, wherein, from access control principles each defining an object on the information processing device and a condition which permits access to the object, the processor selects access control principles for a common object, and combines the selected access control principles to generate the access control information.

3. The apparatus according to claim 1, wherein after distributing the access control information, the processor stores a log in a memory, the log including the distributed access control information and information about the destination device.

4. A computer-readable, non-transitory medium storing a program to distribute access control information, the program causing a computer to execute processing comprising:
determining a destination device to which access control information is to be distributed, the access control information describing an object on an information processing device and a condition which permits access to the object, on the basis of at least the condition or an attribute of the object; and
distributing the access control information to the determined destination device.

5. A method of distributing access control information, the method comprising:
determining, by a computer, a destination device to which access control information is to be distributed, the access control information describing an object on an information processing device and a condition which permits access to the object, on the basis of at least the condition or an attribute of the object; and
distributing the access control information to the determined destination device.

6. An apparatus to distribute access control information, the apparatus comprising:
a determining mechanism to determine a destination device to which access control information is to be distributed, the access control information describing an object on an information processing device and a condition which permits access to the object, on the basis of at least the condition or an attribute of the object; and
a distributing mechanism to distribute the access control information to the determined destination device.
